(19) United States
(12) Patent Application Publication
(10) Pub. No.: US 2026/0359627 A1
(43) Pub. Date: Nov. 12, 2026

(54) Quantum-Derived Positional Encoding For Large Language Models

(71) Applicant: Multiverse Computing S.L., DONOSTIA - SAN SEBASTIÁN (ES)

(72) Inventors: Borja Aizpurua, DONOSTIA-SAN SEBASTIÁN (ES); Roman Orus, DONOSTIA-SAN SEBASTIÁN (ES)

(21) Appl. No.: 19/421,282

(22) Filed: Dec. 16, 2025

(30) Foreign Application Priority Data
May 12, 2025 (EP) 25 383 376.8

(51) Int. Cl. G06N 3/08; G06N 3/045; G06N 10/20; G06N 10/40

(52) U.S. Cl. CPC G06N 3/08; G06N 3/045; G06N 10/20; G06N 10/40

(57) ABSTRACT

A method and system for training a transformer-based language model, in particular a large language model, or inferring using a transformer-based language model, in particular a large language model, with a hybrid quantum-classical pipeline comprising a classical processor and a quantum processor, wherein . the model comprises a transformer layer, the method comprising: inputting a prompt comprising a sequence of tokens in the classical processor; constructing, with the classical processor, a token graph from the prompt, wherein the token graph comprises a plurality of nodes linked by a plurality of edges, with each token represented by a node in the token graph, and the edges representing semantic, syntactic, and/or statistical relationships between the tokens; evolving the token graph on the quantum processor to generate quantum positional encoding; injecting, by the classical processor, the quantum positional encodings into the model; processing of the prompt by the model using the quantum positional encodings.

### CROSS-REFERENCE TO RELATED APPLICATIONS

None.

### BACKGROUND OF THE INVENTION

### Field of the Invention

The field of the invention relates to transformer-based language models, in particular large language models (LLMs). In particular, the invention relates to a system and method of training a transformer-based language model, in particular a large language model, or inferring using a transformer-based language model in particular a large language model.

### Brief Description of the Related Art

In deep learning, a transformer is an architecture based on multi-head attention mechanism, in which text is converted to numerical representations called tokens, and each token is converted into a vector. At each layer, each token is then contextualized within the scope of the context window with other (unmasked) tokens via a parallel multi-head attention mechanism, allowing the signal for key tokens to be amplified and less important tokens to be diminished. Positional encodings are used to indicate the relative or absolute position of tokens in a sequence; this is required since transformers process tokens in parallel.

Transformers have the primary following components: tokenizers, which convert text into tokens; embedding layer, which converts tokens and positions of the tokens into vector representations; transformer layers, which carry out repeated transformations on the vector representations, extracting more and more information. These consist of alternating attention and feedforward layers. There are two major types of transformer layers: encoder layers and decoder layers, with further variants; and un-embedding layer, which converts the final vector representations back to a probability distribution over the tokens.

Language models are transformer-based models for processing language related input i.e. text written in natural language such as English, German, French, and so on and heavily rely on positional encoding mechanisms to capture the order and structure of input sequences. In recent years, the number of parameters used for transformer-based language models has increased drastically, therefore, most state-of-the-art models are referred to as large language models (LLMs).

The positional encodings are added to input embeddings before being passed into the attention layers of the model, as seen on FIG. 1, where the positional encodings are used for both the encoder and decoder stacks of the LLM.

Standard positional encodings are typically implemented as sinusoidal or rotary embeddings. Sinusoidal Positional Encodings uses constant vectors built with sine and cosine functions. Rotary Positional Encodings, implemented in Llama models, uses constant vectors built with rotational matrices.

Standard Positional encodings are deterministic and static. As models grow in size and are deployed in diverse environments, challenges arise in maintaining inference efficiency, generalization across structured inputs, and energy consumption, especially on edge or resource-constrained platforms.

Furthermore, standard positional encoding schemes are unable to capture higher-order or non-local dependencies that often exist in language, graphs, or structured prompts. This limitation reduces the model's ability to reason over structural patterns or hierarchical context effectively. Therefore, such methods are limited in their ability to reflect deeper structural or contextual relationships among tokens.

Existing techniques to address these limitations, such as learned embeddings or attention-based adjustments, introduce additional computational or memory overhead and require retraining or fine-tuning of the model.

Quantum positional encodings (QPEs) generate positional encodings by using (physical) quantum devices such as quantum computers and/or quantum simulators; these could be analog, digital or (mixed) digital-analog systems. For example, QPEs may be generated by simulating the quantum evolution of a graph-structured representation of the input prompt.

In the two related preprints (by the same authors and building on each other) “Quantum Positional Encodings for Graph Neural Networks”, arXiv:2406.06547, and “Enhancing Graph Neural Networks with Quantum Computed Encodings” arXiv:2310.20519, the use of QPEs for graph learning tasks on graph neural networks (GNNs) are disclosed. Herein, graph representations and corresponding node embeddings are constructed, which may be used for a transformer architecture adapted to the task. However, these QPEs are not adapted to language models i.e. to text inputs and rely on a static graph structure with fixed connectivity.

It is therefore one object of the present document to provide a solution to represent complex, context-dependent relationships between tokens.

### BRIEF SUMMARY OF THE INVENTION

This object is achieved by the invention by providing a method according to claim 1 and a computational system according to claim 10.

The present invention addresses these limitations by introducing a mechanism to generate richer, adaptive positional representations through quantum computational techniques, without modifying the underlying model architecture or increasing its computational burden. Unlike QPEs used for GNNs in the prior art, the present invention dynamically constructs a new graph for each textual prompt, enabling context-dependent positional encoding rather than fixed graph node embeddings. A method allowing for a dynamic graph generation with different graphs for different inputs is useful for language models.

In a first aspect, the invention provides a method of training a transformer-based language model, in particular a large language model, or inferring using a transformer-based language model, in particular a large language model, with a hybrid quantum-classical pipeline comprising a classical processor and a quantum processor, wherein said model comprises a transformer layer, the method comprising:
inputting a prompt comprising a sequence of tokens in the classical processor;
constructing, with the classical processor, a token graph from the prompt, wherein the token graph comprises a plurality of nodes linked by a plurality of edges, with each token represented by a node in the token graph, and the edges representing semantic, syntactic, and/or statistical relationships between the tokens,
evolving a quantum state associated to the token graph on the quantum processor to generate quantum positional encodings;
injecting, by the classical processor, the quantum positional encodings into the model; and
processing of the prompt by the model using the quantum positional encodings.

This invention introduces a method to enhance transformer-based language models, in particular large language models (LLMs), by integrating positional information derived from quantum processing systems into LLM pipelines. Positional information derived from quantum processing systems is called “quantum positional encodings” (QPEs).

A quantum state associated to the token graph is evolved. This state may be obtained by mapping each token (node) in the graph to a qubit with its initial state (for example, |0 [symbol] , |+ [symbol] , or a parametrized superposition) representing the token's baseline embedding or uniform initialization before evolution.

Compared with the prior art the application and execution context are transformed from “quantum features for graph nodes” to “dynamic positional encodings for tokenized language sequences”.

The invention provides a token graph generation procedure specific to text sequences i.e. text inputs. With the method, real-time generation of QPEs on analog quantum devices or simulators can be achieved. Resulting operational advantages include plug-in use, inference acceleration, and improved long-range reasoning.

In particular, the invention allows for real-time QPE generation on quantum devices and enables an inference-time integration. The method integrates QPEs at inference time into an already trained LLM. The model weights remain frozen—there is no re-training or fine-tuning of the LLM itself.

Note that the invention is not limited to using text sequences as input. The method applies to any data that can be represented as a sequence or graph of discrete elements—including time-series signals, symbolic sequences, molecular structures, or multimodal inputs. The core concept is the generation of quantum-derived positional encodings (QPEs) from a dynamically constructed token graph, regardless of the domain of the tokens. Text is therefore just one illustrative case of the broader framework.

Optionally, a lightweight alignment or calibration step can be applied to match the statistical properties of the QPEs to the model's embedding space. This enables quantum-derived positional features to be computed dynamically for each new prompt, without altering or re-optimizing the model's attention layers, resulting in faster experimentation and lower integration cost.

In an aspect, the token graph is dynamically generated for each input prompt during inference.

This allows capturing context-dependent, transient relationships between words that classical positional encodings or static graph structures cannot represent.

In a further aspect, evolving the token graph on a quantum processor comprises simulating the quantum evolution of the quantum state associated to the token graph using an analog quantum processor, such as a neutral-atom-based device.

In this case, the QPEs are derived from graph evolution via quantum simulation, and not for example via QUBO optimization.

In an aspect, the quantum positional encodings are generated from quantum correlations obtained by the application of the Hamiltonian evolution.

The Hamiltonian may be derived from the edges of the token graph. For example, the interaction terms and coupling strengths Jᵢⱼ in the Hamiltonian may be obtained from the edges and, in particular, may be related to the edge weights. The Hamiltonian may for example be an Ising Hamiltonian of the form

$$H = {\sum }_{ij} {J}_{ij} {Z}_{i} {Z}_{j} .$$

In an aspect, the method comprises associating the plurality of token nodes with a plurality of measurement quantum states and measuring or projecting to the measurement quantum states after evolution, producing quantum derived vectors, wherein the quantum positional encodings are the quantum derived vectors.

In another aspect, the step of constructing the token graph comprises applying natural language processing techniques, to determine semantic, syntactic, and/or statistical relationships between tokens for defining the edges of the token graph.

The natural language processing techniques may include at least one of at least one of dependency parsing, co-occurrence analysis, or attention-weight extraction.

In yet another aspect, the transformer-based language model has an attention layer and an embedding layer and the step of injecting the quantum positional encodings into the model comprises injecting the quantum positional encodings into at least one of the attention mechanism or the embedding layer of the model.

In a further aspect, the method comprises injecting the quantum positional encodings at injection points in at least one of the input layer, and the mid-layer of the model, based on empirical evaluation of layer sensitivity to positional information, model architecture characteristics, or desired trade-off between inference efficiency and contextual performance.

In a further aspect, the method comprises projecting the quantum-derived vectors through a dimensionality-alignment function, such as a linear transformation, normalization, or embedding-space calibration layer, to match a dimensionality and statistical distribution of the models embedding space.

According to another aspect, the transformer-based language model is applied to multimodal data including natural language, tabular, or graph-structured inputs.

Multimodal data arises in many applications, for example when data from different sources is combined. This aspect highlights that the advantages of the method are present when processing such datasets.

In one aspect, metrics are measured to evaluate QPE generation latency, throughput, and reliability during inference.

The method proposes evaluation metrics beyond standard NLP benchmarks, such as long-range dependency resolution, structural reasoning accuracy, and energy efficiency during inference.

The invention also provides a computing system for training a transformer-based language model, in particular a large language model, or inferring using a transformer-based language model, in particular a large language model, comprising a classical processor and a quantum processor, wherein
the classical processor comprises an input module for receiving a prompt comprising a sequence of tokens;
the classical processor being configured for
   constructing a token graph from the prompt, wherein the token graph comprises a plurality of nodes linked by a plurality of edges, with each token being a node in the token graph, and with the edges representing semantic, syntactic, and/or statistical relationships between the tokens;
   injecting quantum positional encodings into the model;
   processing of the prompt by the model using the quantum positional encodings;
and wherein the quantum processor is configured for generating the quantum positional encodings, wherein the generation of quantum positional encodings comprises evolving the token graph, including applying a Hamiltonian evolution to the token graph to generate quantum positional encodings.

This hybrid setup provides an execution advantage. The quantum processor acts as a pre-processing module that enriches positional signals while leaving the classical inference untouched. This architecture enables parallelization and latency hiding, as QPEs can be generated asynchronously on the quantum device or emulator. It reduces total inference time and improves the utilization efficiency of analog devices, making the approach practical even on current NISQ hardware.

The invention further provides a computer program product, which, if executed on a computing system as above, performs a method as above.

Moreover, the invention provides non-volatile computer readable medium storing instructions that, when executed by a computing system as above, cause the system to perform the method as above.

Unlike the prior art, the invention includes explicit projection and calibration mechanisms between the quantum output space and the LLM's embedding space. This ensures cross-model compatibility and allows QPEs to be reused across LLM architectures of varying hidden dimensions.

With the method of the invention, the resulting positional embeddings capture long-range semantic and syntactic structure more effectively than deterministic encodings. This improves context retention, robustness under compression or quantization, and performance in sparse or ambiguous prompts. These advantages can be demonstrated even on small-scale NISQ systems through empirical metrics such as dependency resolution and inference efficiency.

The method leverages quantum-computed representations of input sequences to augment or replace standard positional encodings within neural network architectures, improving model performance and efficiency. The technique operates in a hybrid quantum-classical pipeline and is compatible with a range of quantum hardware platforms and transformer-based models. This architecture enables the use of structurally enriched embeddings without modifying the core model weights or training procedures.

The skilled person understands that the attention mechanism is not modified, but rather quantum positional encodings are injected into the existing transformer pipeline. Thus, allowing for an inference-time integration of QPEs into a pipeline with a (pre-)trained LLM. This does not require retraining or fine-tuning and is compatible with existing LLM architectures. There is no modification of weight matrices, quantization levels, or training loss.

With other words, the method of this document proposes information enhancement via quantum embeddings during inference.

### DESCRIPTION OF THE FIGURES

FIG. 1 shows a transformer model architecture.

FIG. 2 shows a workflow of a method according to the present document.

FIG. 3 shows a hybrid quantum-classical pipeline according to the present document.

FIG. 4 shows a schematic illustration of a token graph.

FIG. 5 shows a schematic illustration of the time-evolved token graph during different points in time.

### DETAILED DESCRIPTION OF THE INVENTION

The invention will now be described with reference to the drawings. It will be understood that the embodiments and aspects of the invention described herein are only examples and do not limit the protective scope of the invention in any way. It will be understood that features of one aspect or embodiment of the invention can be combined with a feature of a different aspect or aspects and/or embodiments of the invention.

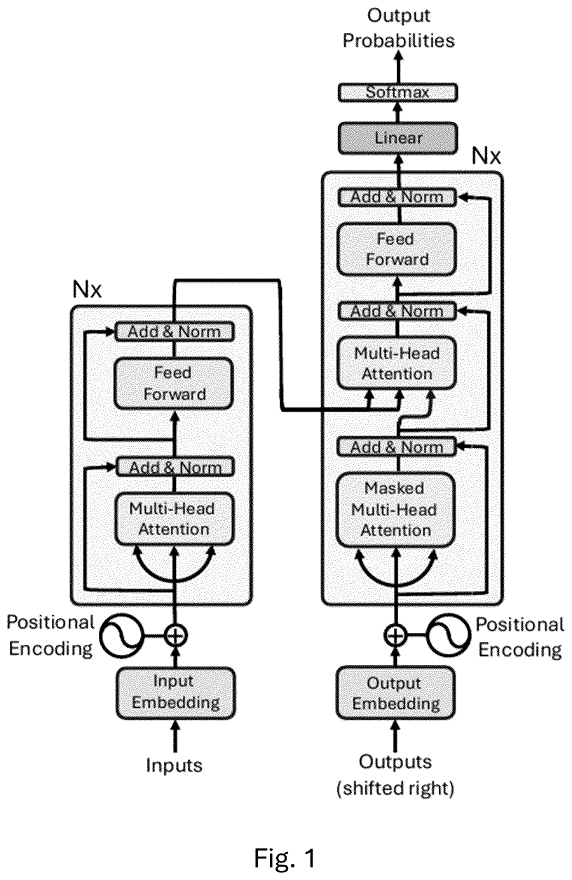

In the transformer shown in FIG. 1, this invention proposes a replacement or augmentation of a Positional Encoding component (shown being used for both the encoder and decoder stacks) with quantum positional encodings (QPEs) 30.

Quantum positional encodings (QPEs) 30 are quantum-derived vectors, which are computed per token based on a graph representation of a prompt 10 and evolved through a Hamiltonian on a quantum processor 126.

This change is minimally invasive: it does not alter the transformer architecture itself but instead improves the positional signal injected into the model 40, resulting in structurally enriched and context-aware inference.

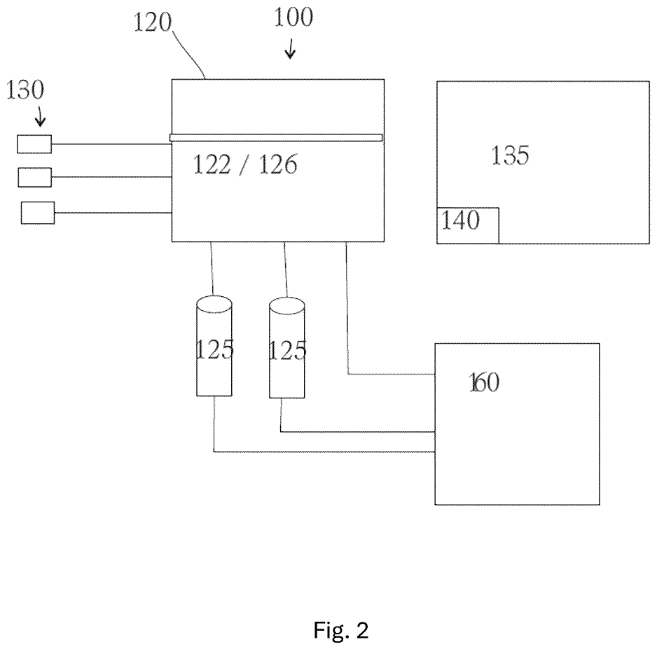

FIG. 2 shows an overview of a typical system which can be used for performing the method set out in this document. The computing system 100 comprises, in an example, a hybrid quantum-classical central processing unit 120 with a classical processor 122 and a quantum processor 126. The hybrid quantum-classical central processing unit 120, which is connected to a data storage unit 125 (i.e., one or more memory devices), and a plurality of input/output devices 130. The input/output devices 130 enable input of prompt 10 and an output of a result.

The quantum processor 126 is provided to act as a pre-processing module generating quantum positional encodings asynchronously while the classical processor 122 is provided to execute the transformer inference.

The input/output devices 130 include tools for users to input prompt 10, or define problem or parameters such as Hamiltonians, injection points of the QPE, vector parameters as will become clear later.

A graphics processing unit 135 for processing vector calculations and a field programmable gate array (FGPA) 140 for control logic that can also be connected to the central processing unit 120. The central processing unit 120 and/or the graphics processing unit 135 have a tensorization circuit and a variational circuit for the inference.

The variational circuit 123 can be a quantum processor based on quantum hardware.

The quantum processor 126 is configured to evolve the token graph 20. The quantum processor 126 can include gate-based quantum circuits, quantum annealing circuits, variational quantum circuits such as parameterized quantum circuit (PQC), also known as an “ansatz” circuit. Quantum annealers can be used to generate variational states for the qubits, where variational parameters are the couplings of the annealing Hamiltonian and other annealing parameters (such as, but not limited to annealing schedule, extra magnetic fields).

The variational circuit 123 for the inference can be an ansatz circuit.

The computing system 100 may be connected to a measurement or projection system 160, such as a fluorescence-based or absorption-imaging detection system configured to measure the final quantum states of the qubits or atomic ensemble. The measurement system 160 performs state readout via site-resolved imaging or global photonic detection, from which expectation values or correlation functions are computed to derive the Quantum Positional Encoding (QPE) vectors.

It will be appreciated that the computing system 100 of FIG. 2 is merely exemplary and other units or elements may be present in the computing system 100. It will also be appreciated that there may be many input/output (I/O) devices 130 located at multiple locations and that there may be a plurality of data storage units 125 also located at multiple locations. The many I/O devices 130 and data storage units 125 are connected by the computer network 160.

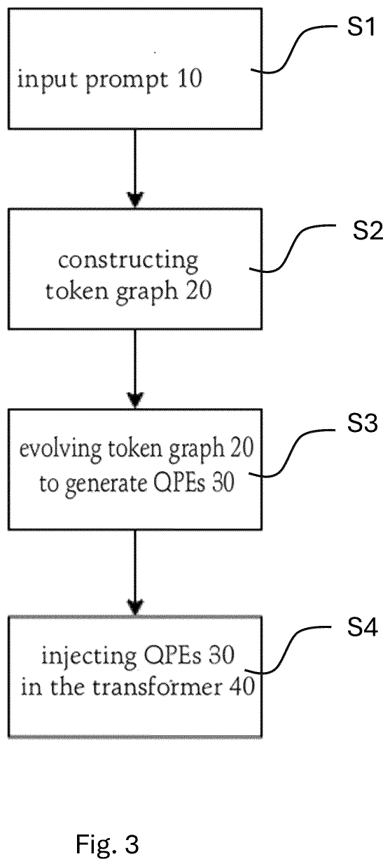

The method will be described with reference to FIG. 3 and can be implemented by a hybrid quantum-classical pipeline as shown on FIG. 2.

The method starts with a prompt 10 received by the classical processor 122 (step S1). The prompt 10 is sent via a user input interface of the classical processor 122.

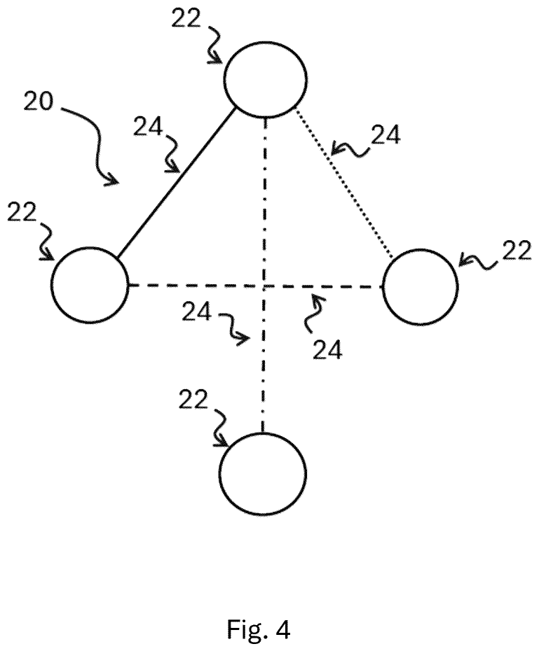

At step S2, a token graph 20 is constructed from the prompt 10, by the classical processor 122. The classical processor 122 analyses the prompt 10 and derives semantic, syntactic, and/or statistical relationships between the tokens can be based on co-occurrence, dependency parsing, or attention patterns. Based on the prompt analysis, a token graph 20 is constructed, with (token graph) nodes 22 and (token graph) edges 24 linking the nodes 22 An example of token graph 20 is shown on FIG. 4. In a token graph 20, each token is represented by a node 22 in the token graph 20, and the edges 24 represent semantic, syntactic, and/or statistical relationships between the tokens. The edges 24 are weighted, which is represented by different line styles in FIG. 4. There can be edges 24 between all nodes 22 or only between certain nodes 22. As discussed above, one may want to control the number of edges 24 due to limited computational resources. In this case, potential edges 24 with a weight below a certain threshold, with a magnitude in a certain range, etc. can be removed during construction of the final token graph 20 to be simulated.

The token graph 20 is constructed by analysing the prompt 10 with classical NLP techniques such as dependency parsing, attention-score analysis, or statistical co-occurrence.

The edges are weighted based on co-occurrence frequency, attention weight magnitude, or syntactic dependency strength between tokens.

In the token graph 20, tokens are represented as nodes 22, and weighted edges 24 are created between nodes 22 associated with tokens that exhibit syntactic dependencies or high contextual correlation in the model's attention maps. The token graph 20 is transformed into a resulting adjacency matrix A which defines the graph topology.

The adjacency matrix A represents the relationships between token pairs, with each entry Aᵢⱼ corresponding to the edge weight or coupling strength Jᵢⱼ between tokens i and j. Depending on the embodiment, the matrix can be binary (indicating only connectivity), weighted (reflecting normalized interaction strengths), or asymmetric if directional dependencies between tokens are to be captured. Any of these variants can be used to define the Hamiltonian governing the quantum evolution.

To fit current analog-QPU limits (≈15-30 nodes), only the most significant nodes 22 and edges 24—based on attention weights or syntactic importance—are retained.

Edge weights are normalized to maintain connectivity while preserving key contextual relationships, and low-influence nodes 22 or weak connections are pruned to yield a sparse, computationally tractable token graph 20 suitable for Hamiltonian evolution. The token graph 20 is passed to a quantum processor 126 and evolved on the quantum processor to generate or extract Quantum Positional Encodings (QPEs) 30, in step S3.

Evolving the token graph 20 on the quantum processor comprises simulating the quantum evolution of the token graph 20 using an analog quantum processor 126, such as a neutral-atom-based device.

QPEs 30 are generated from quantum correlations obtained by the application of the Hamiltonian evolution. More precisely, the application of the Hamiltonian evolution comprises associating the plurality of nodes 22 with a plurality of measurement quantum states after the evolution, and measuring or projecting to the measurement quantum states after evolution, and producing quantum derived vectors, wherein the QPEs 30 are the quantum derived vectors. Measuring or projecting to the measurement quantum states after evolution can be done through site-resolved fluorescence detection or photonic readout, allowing extraction of single-and two-qubit expectation values (e.g., [symbol] σ^{z}ᵢ [symbol] , [symbol] σ^{z}ᵢσ^{z}ᵢ [symbol] ). These measured observables are then classically post-processed to construct the QPE vectors used in the model 40. Parametrized Hamiltonians can be used to generate the QPEs 30. A quantum state can be constructed from the token graph 20 and evolved by a parametrized Hamiltonian. The Hamiltonian can be selected from a class of parametrized spin Hamiltonians, including Ising-type (ZZ) or XY-type, where coupling parameters correspond to edge weights in the token graph 20. For example, the Hamiltonian may be an Ising Hamiltonian

$$H = {\sum }_{ij} {J}_{ij} {Z}_{i} {Z}_{j} ,$$

wherein the coupling parameters (i.e. coupling strengths) Jᵢⱼ correspond to the weights between node i and node j in the token graph 20.

An ansatz can be used to evolve the token graph 20.

The QPEs 30 are generated by sampling the evolved quantum states and computing expectation values or correlation matrices between qubits representing token relationships. These measurements are normalized and projected into the embedding space, yielding one quantum-derived positional vector per token. The QPEs 30 can then be injected in place of or alongside standard positional embeddings of transformer models 40.

With other words, the QPEs 30 are injected into LLM inference pipeline, into the attention mechanism or the embedding layer.

It should be noted that QPEs 30 are derived from the graph evolution via quantum simulation. There is no modification of the attention mechanism but rather an injection of quantum positional encodings 30 into the existing transformer pipeline.

It is possible to inject the QPEs 30 at different injection points 35 such as in the input layer or mid-layer, or hybrid strategies in transformer architectures. The choice of injection points 35 can be based on empirical performance and layer sensitivity analyses, such as evaluating attention-head activation strength or positional-information loss across layers. In practice, QPEs 30 can be injected where positional signals have the greatest impact—typically the input embedding layer for global coherence or selected mid-layers to reinforce long-range dependencies in compressed or pruned models 40.

In one aspect, the method comprises aligning the quantum derived vectors of the QPEs 30 to LLM's embedding space. Alignment is achieved through a linear or nonlinear projection layer (e.g., PCA, learned affine transform, or kernel mapping) that rescales and rotates the QPE vectors to match the dimensionality and statistical distribution of the models embedding space, ensuring compatibility across models 40 with different hidden sizes. Further exploration of dimensionality reduction and projection methods to align quantum output vectors with the models embedding space and or calibration strategies. Calibration strategies to ensure compatibility across LLM variants with differing hidden sizes.

By injecting QPEs 30 into compact transformer models 40, the positional signal of the prior art encoding method, which is often degraded during compression, is re-enriched using structure-aware, quantum-derived embeddings.

The number of dimensions of the quantum positional encoding vector per token corresponds to the number of observables measured per qubit (e.g., [symbol] X [symbol] , [symbol] Y [symbol] , [symbol] Z [symbol] ), or a post-processed projection thereof to match the LLM embedding dimension.

QPEs 30 are not degraded during compression because they encode relational structure directly in the embedding space through quantum correlations rather than relying on parameterized attention weights. This means their information content is independent of model width or head count, allowing the structural cues they provide to remain intact even when the transformer is pruned, quantized, or otherwise compressed.

This quantum augmentation enhances the model's ability to: disambiguate tokens with syntactic overlap, preserve long-range dependencies even when attention heads are pruned, and/or improve structural reasoning in sparse or ambiguous prompts.

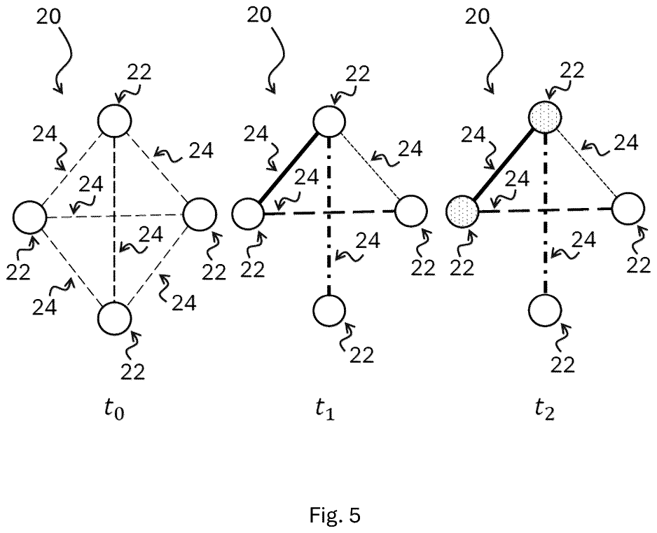

FIG. 5 shows a schematic illustration of the time-evolved token graph during different points in time.

Note that, as described above, a quantum state associated to the token graph 20 evolved on the quantum processor 126. In that sense, FIG. 5 illustrates a token graph 20 to which the evolved quantum state could be mapped at different stages of the evolution, i.e. different points in time.

In the FIG. 5, circles represent nodes 22 of the token graph 20 and lines represent edges 24 between said nodes 22. Different line styles of the edges 24 represent different weights and different shadings of the circles represent different states of the nodes 22 i.e. different states of the associated qubits.

As shown in the FIG. 5, both the weights and the node states can and will typically change during the evolution. The initial state at t₀ features equal node states (empty circles) and equal weights (dashed lines). Between t₀ and t₁ the weights change-some lines disappear symbolizing vanishing weights, while other lines become thicker symbolizing larger weights. Between t₁ and t₂ the node states change, with the upper and left nodes being shaded symbolizing a different node state i.e. different qubit state in the quantum state.

Note that typically both the weights and the node states will change simultaneously. In the FIG. 5 this is simplified by separating these changes for better visualization.

In summary, the present document proposes information enhancement via quantum embeddings during inference. The approach of this document is focused on embedding-level integration rather than architectural parameter optimization. There is no need to modify the attention mechanism, and no need to modify weight matrices, quantization levels, or training loss of the language model 40. Similarly, the present approach does not require retraining or fine-tuning and is compatible with existing LLM architectures. Rather, the present document proposes injects quantum positional encodings 30 into the existing transformer pipeline.

### REFERENCE NUMBERS

10 prompt
20 token graph
22 (token graph) node
24 (token graph) edge
30 quantum positional encodings
35 injection points
40 transformer-based language model
100 computing system
120 hybrid unit
122 classical processor
123 variational circuit
125 data storage unit
126 quantum processor
130 input/output devices
135 graphics processing unit
160 measurement or projection system

What is claimed is:

1. A method of training a transformer-based language model, in particular a large language model, or inferring using a transformer-based language model, in particular a large language model, with a hybrid quantum-classical pipeline comprising a classical processor and a quantum processor,
wherein said model comprises a transformer layer, the method comprising:
inputting a prompt comprising a sequence of tokens in the classical processor;
constructing, with the classical processor, a token graph from the prompt, wherein the token graph comprises a plurality of nodes linked by a plurality of edges, with each token represented by a node in the token graph, and the edges representing semantic, syntactic, and/or statistical relationships between the tokens;
evolving a quantum state associated to the token graph on the quantum processor to generate quantum positional encodings;
injecting, by the classical processor, the quantum positional encodings into the model; and
processing of the prompt by the model using the quantum positional encodings.

2. The method according to claim 1, wherein the token graph is dynamically generated for each input prompt during inference.

3. The method according to claim 1, wherein evolving the quantum state associated to the token graph on a quantum processor comprises simulating the quantum evolution of the token graph using an analog quantum processor, such as a neutral-atom-based device.

4. The method according to claim 1, wherein quantum positional encodings are generated from quantum correlations obtained by the application of the Hamiltonian evolution.

5. The method according to claim 3, comprising:
associating the plurality of token nodes with a plurality of measurement quantum states;
measuring or projecting to the measurement quantum states after evolution; and
producing quantum derived vectors from said measurements, wherein the quantum
positional encodings are the quantum derived vectors.

6. The method according to claim 1 wherein the step of constructing the token graph comprises applying natural language processing techniques, to determine semantic, syntactic, and/or statistical relationships between tokens for defining the edges of the token graph.

7. The method according to claim 5, wherein the natural language processing techniques include at least one of at least one of dependency parsing, co-occurrence analysis, or attention-weight extraction.

8. The method according to claim 1, wherein the transformer-based language model has an attention layer and an embedding layer and wherein the step of injecting the quantum positional encodings into the model comprises injecting the quantum positional encodings into at least one of the attention mechanism or the embedding layer of the model.

9. The method according to claim 7, comprising injecting the quantum positional encodings at injection points in at least one of the input layer, and the mid-layer of the model, based on empirical evaluation of layer sensitivity to positional information, model architecture characteristics, or desired trade-off between inference efficiency and contextual performance.

10. The method according to claim 1, comprising projecting the quantum-derived vectors through a dimensionality-alignment function, such as a linear transformation, normalization, or embedding-space calibration layer, to match the dimensionality and statistical distribution of the models embedding space.

11. The method according to claim 1, wherein the transformer-based language model is applied to multimodal data including natural language, tabular, or graph-structured inputs.

12. A computing system for training a transformer-based language model, in particular
a large language model, or inferring using a transformer-based language model, in particular a large language model, comprising a classical processor and a quantum processor, wherein
the classical processor comprises an input module for receiving a prompt comprising a sequence of tokens;
the classical processor being configured for:
constructing a token graph from the prompt, wherein the token graph comprises a plurality of nodes linked by a plurality of edges, with each token being a node in the token graph, and with the edges representing semantic, syntactic, and/or statistical relationships between the tokens;
injecting quantum positional encodings into the model; and
processing of the prompt by the model using the quantum positional encodings;
and wherein the quantum processor is configured for generating the quantum positional encodings, wherein the generation of quantum positional encodings comprises evolving the token graph, including applying a Hamiltonian evolution to the token graph to generate quantum positional encodings.

13. A computer program product, which, if executed on a computing system according to claim 12, performs a method of training a transformer-based language model, in particular a large language model, or inferring using a transformer-based language model, in particular a large language model, with a hybrid quantum-classical pipeline comprising a classical processor and a quantum processor,
wherein said model comprises a transformer layer, the method comprising:
inputting a prompt comprising a sequence of tokens in the classical processor;
constructing, with the classical processor, a token graph from the prompt, wherein the token graph comprises a plurality of nodes linked by a plurality of edges, with each token represented by a node in the token graph, and the edges representing semantic, syntactic, and/or statistical relationships between the tokens;
evolving a quantum state associated to the token graph on the quantum processor to generate quantum positional encodings;
injecting, by the classical processor, the quantum positional encodings into the model; and
processing of the prompt by the model using the quantum positional encodings.

14. A non-volatile computer readable medium storing instructions that, when executed by a computing system according to claim 12, cause the system to perform a method of training a transformer-based language model, in particular a large language model, or inferring using a transformer-based language model, in particular a large language model, with a hybrid quantum-classical pipeline comprising a classical processor and a quantum processor,
wherein said model comprises a transformer layer, the method comprising:
inputting a prompt comprising a sequence of tokens in the classical processor;
constructing, with the classical processor, a token graph from the prompt, wherein the token graph comprises a plurality of nodes linked by a plurality of edges, with each token represented by a node in the token graph, and the edges representing semantic, syntactic, and/or statistical relationships between the tokens;
evolving a quantum state associated to the token graph on the quantum processor to generate quantum positional encodings;
injecting, by the classical processor, the quantum positional encodings into the model; and
processing of the prompt by the model using the quantum positional encodings.
